(19) United States
(12) Patent Application Publication
(10) Pub. No.: US 2026/0359490 A1
(43) Pub. Date: Nov. 12, 2026

(54) COMMUNICATING DATA SECURITY INFORMATION VIA A SIDEBAND IN A MEMORY SYSTEM

(71) Applicant: Micron Technology, Inc., Boise, ID (US)

(72) Inventors: Scott E. Schaefer, Boise, ID (US); Frank F. Ross, Boise, ID (US); Anthony D. Veches, Boise, ID (US); Sujeet V. Ayyapureddi, Boise, ID (US); Randall J. Rooney, Boise, ID (US); Navid Lashkarian, Pleasanton, CA (US); Matthew A. Prather, Boise, ID (US); Lance W. Dover, Fair Oaks, CA (US)

(21) Appl. No.: 19/655,368

(22) Filed: Apr. 22, 2026

Related U.S. Application Data
(60) Provisional application No. 63/802,424, filed on May 8, 2025.

(51) Int. Cl. G06F 21/64; G06F 21/85

(52) U.S. Cl. CPC G06F 21/64; G06F 21/85

(57) ABSTRACT

Methods, systems, and devices for communicating data security information via a sideband in a memory system are described. For example, the memory system may use one or more multi-function pins or subsets of bits within data bursts to communicate security information via the sideband while communicating data via a data channel between the memory system and a host system. The security information may indicate whether the data is encoded, the encoding format applied to the data, data validation information, command verification information, or an identifier of the memory system, among other examples. The memory system may include one or more mode registers configured to indicate whether communicating the security information via the multi-function pins or subsets of bits is enabled. The memory system may communicate the security information according to the status of the mode registers.

### CROSS REFERENCE

The present Application for Patent claims priority to U.S. Patent Application No. 63/802,424 by Schaefer et al., entitled “COMMUNICATING DATA SECURITY INFORMATION VIA A SIDEBAND IN A MEMORY SYSTEM,” filed May 8, 2025, which is assigned to the assignee hereof, and which is expressly incorporated by reference in its entirety herein.

### TECHNICAL FIELD

The following relates to one or more systems for memory, including communicating data security information via a sideband in a memory system.

### BACKGROUND

Memory devices are used to store information in devices such as computers, user devices, wireless communication devices, cameras, digital displays, and others. Information is stored by programming memory cells within a memory device to various states. For example, binary memory cells may be programmed to one of two supported states, often denoted by a logic 1 or a logic 0. In some examples, a single memory cell may support more than two states, any one of which may be stored by the memory cell. To store information, a memory device may write (e.g., program, set, assign) states to the memory cells. To access stored information, a memory device may read (e.g., sense, detect, retrieve, determine) states from the memory cells.

### BRIEF DESCRIPTION OF THE DRAWINGS

FIG. 1 shows an example of a system that supports communicating data security information via a sideband in a memory system in accordance with examples as disclosed herein.

FIGS. 2A and 2B show examples of systems that supports communicating data security information via a sideband in a memory system in accordance with examples as disclosed herein.

FIG. 3 shows a process flow that supports communicating data security information via a sideband in a memory system in accordance with examples as disclosed herein.

FIG. 4 shows a block diagram of a memory system that supports communicating data security information via a sideband in a memory system in accordance with examples as disclosed herein.

FIG. 5 shows a flowchart illustrating a method or methods that support communicating data security information via a sideband in a memory system in accordance with examples as disclosed herein.

### DETAILED DESCRIPTION

Ensuring the security and integrity of data communication between a host system and a memory system may be desirable, especially for security-sensitive applications (e.g., applications that handle data authorized to be accessed by specific users or entities). In some examples, security information may be communicated via a data channel between the host system and the memory system. The memory system may use the data channel to communicate data for read and write operations. However, using the data channel for security information (among other purposes) may result in increased latency and reduced throughput, as the transfer of the security information via the data channel may interfere with (e.g., compete with or otherwise overpower or delay) the transfer of other data traffic (e.g., data from read and/or write commands, which may be referred to as in-band data traffic herein) via the data channel. Further, reducing throughput of the security information may reduce latency of other information, but may result in relatively insufficient security coverage for the memory system, leaving the memory system vulnerable to unauthorized access or data corruption, among other examples.

The techniques described herein support communicating data security information via a sideband of a memory system to improve security information throughput while maintaining or otherwise reducing latency associated with in-band data communications. For example, the memory system may use one or more multi-function pins or subsets of bits within data bursts to communicate security information while communicating data via the data channel. The sideband as described herein may thereby refer to a channel or connection between one or more multi-function pins at the memory system and the host system. Additionally, or alternatively, the sideband as described herein may refer to a portion of a data burst (e.g., subsets of bits) that is conveyed via the in-band data channel, but that is not allocated for (e.g., does not include) in-band data transmission(s). For example, an in-band data transmission may include a burst of data bits formatted according to one or more communication protocols or standards. In some examples, the configured data burst may include data bits and one or more subsets of metadata bits dispersed within the data bits (e.g., interleaved with the data bits). Such metadata bits may be reserved for conveying metadata associated with various functions of the memory system. As described herein, the metadata bits may be repurposed when they are not in use for the other functions to instead be used for conveying security information. The metadata bits, separate from the other data bits in a data burst that convey data, may be referred to or may otherwise represent an example of a sideband channel as described herein (e.g., an allocated portion of resources/bits within the in-band channel dedicated for sideband security signaling).

The security information may indicate whether data stored at the memory system is encoded, the encoding format applied to the data, data validation information, a security tag associated with the data, command verification information, an identifier of the data, an identifier of the memory system (e.g., for authentication), other security metadata or information, or any combination thereof. In some examples, the memory system may monitor one or more mode registers to determine whether communicating the security information via the multi-function pins or subsets of bits is enabled. A status of the one or more mode registers may indicate whether the memory system is to communicate the security information via the sideband or not, and whether the sideband is a multi-function pin, a subset of bits in an in-band data transmission, or both. Communicating the security information via the sideband may improve security coverage, reduce latency, and increase throughput of the memory system, among other examples.

In addition to applicability in memory systems described herein, techniques for communicating data security information via a sideband in a memory system may be generally implemented to improve security and/or authentication features of various electronic devices and systems. As the use of electronic devices for handling private, user, or other sensitive information has become even more widespread, electronic devices and systems have become the target of increasingly frequent and sophisticated attacks. Further, unauthorized access or modification of data in security-critical devices such as vehicles, healthcare devices, and others may be especially concerning. Implementing the techniques described herein may improve the security of electronic devices and systems by increasing the throughput and coverage of security information based on communicating the security information via a sideband between the memory system and a host system and may prevent or mitigate unauthorized access to data or other information, among other benefits.

Features of the disclosure are illustrated and described in the context of systems and architectures. Features of the disclosure are further illustrated and described in the context of a process flow and flowcharts.

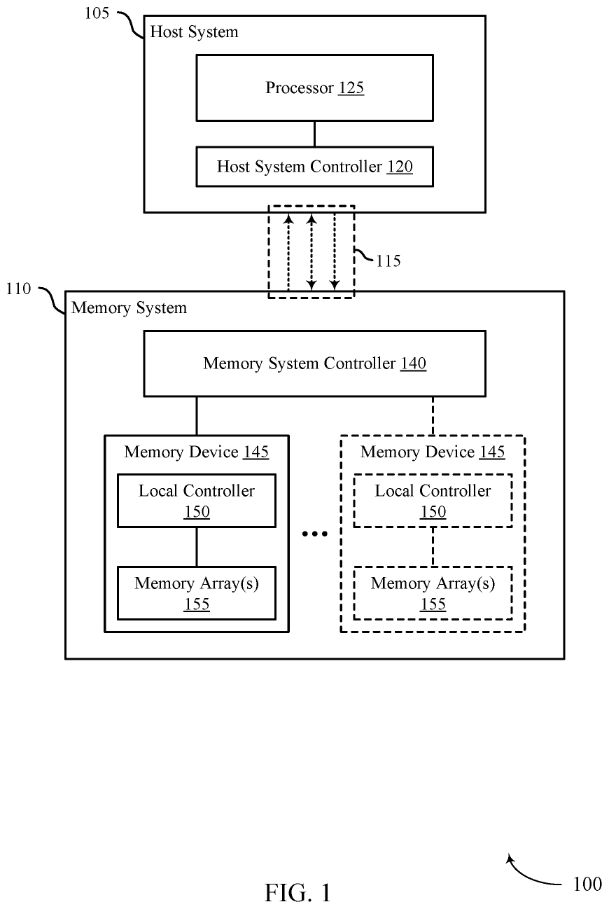

FIG. 1 shows an example of a system 100 that supports communicating data security information via a sideband in a memory system in accordance with examples as disclosed herein. The system 100 may include portions of an electronic device, such as a computing device, a mobile computing device, a wireless communications device, a graphics processing device, a vehicle, a smartphone, a wearable device, an internet-connected device, a vehicle controller, a system on a chip (SoC), or other stationary or portable electronic system, among other examples. The system 100 includes a host system 105, a memory system 110, and one or more channels 115 coupling the host system 105 with the memory system 110 (e.g., to support a communicative coupling). The system 100 may include any quantity of one or more memory systems 110 coupled with the host system 105.

A host system 105 may include one or more components (e.g., circuitry, processing circuitry, application processing circuitry, one or more processing components) that use memory to execute processes (e.g., applications, functions, computations), any one or more of which may be referred to as or be included in a processor 125 (e.g., an application processor). A processor 125 may include at least one of one or more processing elements that may be co-located or distributed, including a general-purpose processor, a digital signal processor (DSP), an application-specific integrated circuit (ASIC), a field-programmable gate array (FPGA) or other programmable logic device, a controller, discrete gate or transistor logic, one or more discrete hardware components, or a combination thereof. A processor 125 may be an example of a central processing unit (CPU), a graphics processing unit (GPU), a general-purpose GPU (GPGPU), or an SoC or a component thereof, among other examples.

A host system 105 may also include at least one of one or more components (e.g., circuitry, logic, instructions) that implement the functions of an external memory controller (e.g., a host system memory controller), which may be referred to as or be included in a host system controller 120. For example, a host system controller 120 may issue commands or other signaling for operating a memory system 110, such as write commands, read commands, configuration signaling or other operational signaling. In some examples, a host system controller 120, or associated functions described herein, may be implemented by or be part of a processor 125. For example, a host system controller 120 may be hardware, instructions (e.g., software, firmware), or a combination thereof implemented by a processor 125 or other component of a host system 105. In various examples, a host system 105 or a host system controller 120 may be referred to as a host.

A memory system 110 provides physical memory locations (e.g., addresses) that may be used or referenced by the system 100. A memory system 110 may include a memory system controller 140 and one or more memory devices 145 (e.g., memory packages, memory dies, portions of a memory die) operable to store data. A memory system 110 may be configurable for operations with different types of host systems 105 and may respond to commands from the host system 105 (e.g., from a host system controller 120). For example, a memory system 110 (e.g., a memory system controller 140) may receive a write command indicating that the memory system 110 is to store data received from a host system 105, or receive a read command indicating that the memory system 110 is to provide data stored in a memory device 145 to a host system 105, or receive a refresh command indicating that the memory system 110 is to refresh data stored in a memory device 145, among other types of commands and operations.

A memory system controller 140 may include at least one of one or more components (e.g., circuitry, logic, instructions) operable to control operations of a memory system 110. A memory system controller 140 may include hardware or instructions that support the memory system 110 performing various operations, and may be operable to receive, transmit, or respond to commands, data, or control information related to operations of the memory system 110. A memory system controller 140 may be operable to communicate with one or more of a host system controller 120, one or more memory devices 145, or a processor 125. In some examples, a memory system controller 140 may control operations of the memory system 110 in cooperation with a host system controller 120, a local controller 150 of a memory device 145, or any combination thereof. Although the example of memory system controller 140 is illustrated as a separate component of the memory system 110, in some examples, aspects of the functionality of the memory system 110 may be implemented by a processor 125, a host system controller 120, at least one of one or more local controllers 150, or any combination thereof.

Each memory device 145 may include a local controller 150 (e.g., a logic controller, an interface controller, one or more processors) and one or more memory arrays 155. A memory array 155 may be a collection of memory cells (e.g., a two-dimensional array, a three-dimensional array, an array of one or more semiconductor components), with each memory cell being operable to store data (e.g., as one or more stored bits). Each memory array 155 may include memory cells of various architectures, such as random access memory (RAM) cells, dynamic RAM (DRAM) cells, synchronous dynamic RAM (SDRAM) cells, static RAM (SRAM) cells, ferroelectric RAM (FeRAM) cells, magnetic RAM (MRAM) cells, resistive RAM (RRAM) cells, phase change memory (PCM) cells, chalcogenide memory cells, not-or (NOR) memory cells, and not-and (NAND) memory cells, or any combination thereof.

A local controller 150 may include at least one of one or more components (e.g., circuitry, logic, instructions) operable to control operations of a memory device 145. In some examples, a local controller 150 may be operable to communicate (e.g., receive or transmit data or commands or both) with a memory system controller 140. In some examples, a memory system 110 may not include a memory system controller 140, and a local controller 150 or a host system controller 120 may perform functions of a memory system controller 140 described herein. In some examples, a local controller 150, or a memory system controller 140, or both may include decoding components operable for accessing addresses of a memory array 155, sense components for sensing states of memory cells of a memory array 155, write components for writing states to memory cells of a memory array 155, or various other components operable for supporting described operations of a memory system 110.

A host system 105 (e.g., a host system controller 120) and a memory system 110 (e.g., a memory system controller 140) may communicate information (e.g., data, commands, control information, configuration information, timing information) using one or more channels 115. Each channel 115 may be an example of a transmission medium that carries information, and each channel 115 may include one or more signal paths (e.g., a transmission medium, an electrical conductor, a conductive path) between terminals (e.g., nodes, pins, contacts) associated with the components of the system 100. A terminal may be an example of a conductive input or output point of a device of the system 100, and a terminal may be operable as part of a channel 115. In some implementations, at least the channels 115 between a host system 105 and a memory system 110 may include or be referred to as a host interface (e.g., a physical host interface). To support communications over channels 115, a host system 105 (e.g., a host system controller 120) and a memory system 110 (e.g., a memory system controller 140) may include receivers (e.g., latches) for receiving signals, transmitters (e.g., drivers) for transmitting signals, decoders for decoding or demodulating received signals, or encoders for encoding or modulating signals to be transmitted, among other components that support signaling over channels 115, which may be included in a respective interface portion of the respective system.

A channel 115 may be dedicated to communicating one or more types of information, and channels 115 may include unidirectional channels, bidirectional channels, or both. For example, the channels 115 may include one or more command/address channels, one or more clock signal channels, one or more data channels, among other channels or combinations thereof. In some examples, a channel 115 may be configured to provide power from one system to another (e.g., from the host system 105 to the memory system 110, in accordance with a regulated voltage). In some examples, at least a subset of channels 115 may be configured in accordance with a protocol (e.g., a logical protocol, a communications protocol, an operational protocol, an industry standard), which may support configured operations of and interactions between a host system 105 and a memory system 110.

A command/address channel (e.g., a CA channel) may be operable to communicate commands between the host system 105 and the memory system 110, including control information associated with the commands (e.g., address information, configuration information). Commands carried by a command/address channel may include a write command with an address for data to be written to the memory system 110 or a read command with an address of data to be read from the memory system 110.

A clock signal channel may be operable to communicate one or more clock signals between the host system 105 and the memory system 110. Clock signals may oscillate between a high state and a low state, and may support coordination (e.g., in time) between operations of the host system 105 and the memory system 110. In some examples, a clock signal may provide a timing reference for operations of the memory system 110. A clock signal may be referred to as a control clock signal, a command clock signal, or a system clock signal. A system clock signal may be generated by a system clock, which may include one or more hardware components (e.g., oscillators, crystals, logic gates, transistors).

A data channel (e.g., a DQ channel) may be operable to communicate (e.g., bidirectionally) information (e.g., data, control information) between the host system 105 and the memory system 110. For example, a data channel may communicate information from the host system 105 to be written to the memory system 110, or information read from the memory system 110 to the host system 105. In some examples, channels 115 may include one or more error detection code (EDC) channels. An EDC channel may be operable to communicate error detection signals, such as checksums or parity bits, which may accompany information conveyed over a data channel.

In some systems 100, ensuring the security and integrity of data communication between the host system 105 and the memory system 110 may be desirable, especially for security-sensitive applications (e.g., applications that handle data authorized to be accessed by specific users or entities). In some memory systems 110, security information may be communicated via a data channel (e.g., a channel 115, an in-band channel) between the host system 105 and the memory system 110. The memory system 110 may also use the data channel to communicate data for read and write operations. However, using the data channel for security information may result in increased latency and reduced throughput, as the security information may compete with regular data traffic (e.g., data from read and write commands). Further, the reduced throughput of security information may result in insufficient security coverage for the system 100, leaving the system 100 vulnerable to unauthorized access or data corruption.

The system 100 as described herein may support communicating data security information via a sideband of the memory system 110. For example, the memory system 110 may use one or more multi-function pins or subsets of bits within data bursts to communicate security information via the sideband while communicating data via the data channel. The security information may indicate whether data stored at the memory system 110 is encoded, the encoding format applied to the data, data validation information, a security tag associated with the data, command verification information, an identifier of the data, an identifier of the memory system 110 (e.g., for authentication), or any combination thereof. In some examples, the memory system 110 may monitor one or more mode registers to determine whether communicating the security information via the multi-function pins or subsets of bits is enabled. Based on the status of the one or more mode registers, the memory system 110 may communicate the security information via the sideband. In some examples, communicating the security information via the sideband may improve security coverage, reduce latency, and increase throughput of the memory system 110.

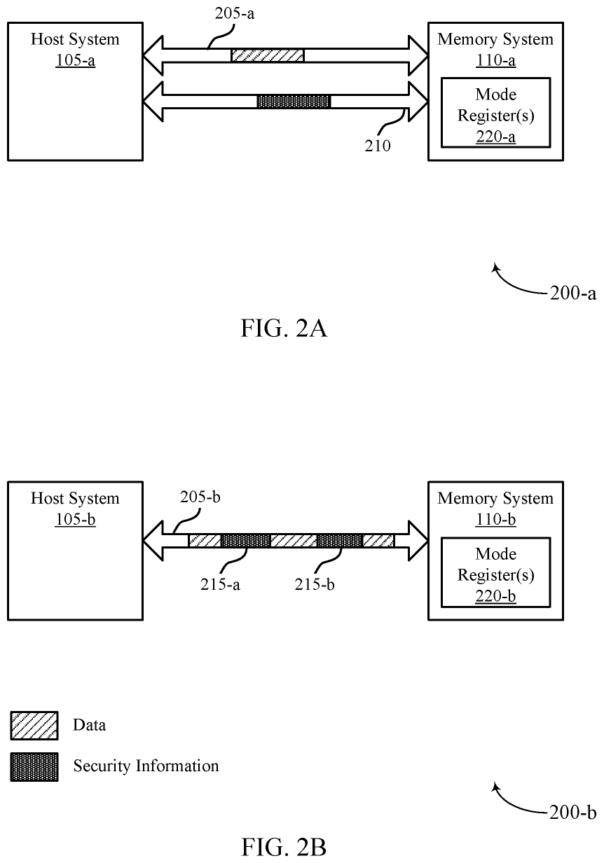

FIGS. 2A and 2B show examples of systems 200 that support communicating data security information via a sideband in a memory system in accordance with examples as disclosed herein. Aspects of the systems 200 may implement, or be implemented by, aspects of the system 100 as described with reference to FIG. 1. For example, the system 200-a may include a host system 105-a and a memory system 110-a, and the system 200-b may include a host system 105-b and a memory system 110-b, which may be examples of the host system 105 and the memory system 110 described with reference to FIG. 1. Each of the memory systems 110-a and 110-b may include one or more mode registers 220.

In some examples, each of the memory systems 110 illustrated in FIGS. 2A and 2B may communicate with a respective host system 105 via a data channel 205 (e.g., a channel 115 described with reference to FIG. 1). The data channel 205 may convey data associated with access commands between a host system 105 and a memory system 110. In some examples, the data channel 205 may additionally include a command/address channel for conveying commands and address information associated with the access commands. The data channel 205 may be referred to as an in-band channel as described herein. In some examples, it may be desirable to increase throughput, coverage, or both, of security information while communicating via the data channel 205. For example, some applications (e.g., security-sensitive applications) may benefit from authenticating the memory system 110, host system 105, or both, or from validating the data communicated via the data channel 205. In accordance with techniques described herein, the memory systems 110-a and 110-b may communicate security information via a sideband between a respective memory system 110 and host system 105 while communicating data via a data channel.

FIG. 2A shows an example of a system 200-a that supports communicating data security information via a sideband in a memory system in accordance with examples as disclosed herein. For example, the memory system 110-a may communicate security information with the host system 105-a via a sideband channel 210 between the host system 105-a and the memory system 110-a. In some examples, the sideband channel 210 may be based on coupling one or more pins (e.g., multi-function pins) of the memory system 110-a with one or more pins of the host system 105-a. That is, the one or more pins at the memory system 110-a may be repurposed or otherwise used in at least some time intervals during operation of the memory system 110-a for exchange of security information, and the repurposed or reused configuration may be referred to as a sideband channel 210 herein.

In some examples, the sideband channel 210 may be based on coupling one or more data mask inversion (DMI) pins of the memory system 110-a with one or more pins of the host system 105-a. A DMI signal (e.g., a signal communicated using one or more DMI pins via the sideband channel 210) may be a bi-directional signal sampled along with DQ signals (e.g., signals communicated via the data channel 205-a) for read operations, write operations, masked write operations, or any combination thereof. The memory system 110-a may use the one or more DMI pins for communicating link ECC or to perform a read data copy function. In some cases, the memory system 110-a may communicate one or more ECC bits via the sideband channel 210 while corresponding data (e.g., the ECC may be generated based on data for a read operation or a write operation) is communicated via the data channel 205-a. For example, during a read operation, the memory system 110-a may output (e.g., transmit) ECC information to the host system 105-a using the one or more DMI pins. The read data copy function may enable the memory system 110-a to copy data transmitted on one DQ pin to one or more other DQ pins.

Additionally, or alternatively, the sideband channel 210 may be based on coupling one or more read data strobe pins (RDQS) of the memory system 110-a with one or more pins of the host system 105-a. In some examples, the one or more RDQS pins may be associated with one or more signals (e.g., an inverted signal communicated using RDQS_c and non-inverted signal communicated using RDQS_t). Signals communicated using the one or more RDQS pins may indicate when read data is available in the data channel 205-a. In some cases, the memory system 110-a may use the one or more RDQS pins (e.g., one or more RDQS_t pins) for communicating link ECC. For example, during a write operation, the memory system 110-a may obtain (e.g., receive) ECC information from the host system 105-a using the one or more RDQS pins. The memory system 110-a may use one or more DMI pins, one or more RDQS pins, or a combination thereof, to communicate security information via the sideband channel 210.

In some examples, the memory system 110-a may communicate security information using the one or more pins for an authentication operation. For example, the memory system 110-a may authenticate an identity of the host system 105-a based on exchanging security information via the sideband channel 210. Additionally, or alternatively, the host system 105-a may authenticate an identity of the memory system 110-a based on exchanging the security information. If the memory system 110-a determines that the host system 105-a is authorized to communicate with the memory system 110-a based on the authentication operation (and/or if the host system 105-a determines the memory system 110-a is authorized to communicate with the host system 105-a), the memory system 110-a and the host system 105-a may communicate via the data channel 205. Otherwise, the memory system 110-a may indicate that the host system 105-a is not authorized to communicate data (e.g., or a subset of data, such as security-sensitive data) with the memory system 110-a, and the memory system 110-a may not communicate with the host system 105-a.

Additionally, or alternatively, the memory system 110-a may communicate security information to validate the data in the data channel 205-a. For example, during a read operation, the memory system 110-a may transmit, via the sideband channel 210, security information that indicates one or more security parameters associated with the data. During a write operation, the memory system 110-a may receive security information via the sideband channel 210 that indicates the one or more security parameters. The one or more security parameters may indicate whether the data is encoded, the type of encoding used on the data (e.g., which encoding format was used), data validation information (e.g., for each data bit, for subsets of data bits), a security tag associated with the data, command verification information, an identity of the data, or any combination thereof. In some cases, the memory system 110-a may communicate the security information based on receiving an access command (e.g., a read or write command) for the security information. For example, the memory system 110-a may receive or transmit the security information irrespective of communicating data via the data channel 205-a.

The memory system 110-a may communicate the security information via the sideband channel 210 using the one or more DMI pins, the one or more RDQS pins, or a combination thereof. For example, the one or more DMI pins or one or more RDQS pins may communicate link ECC using a first quantity of bits. In some examples, the memory system 110-a may communicate the security information using a subset of the first quantity of bits and may communicate link ECC (or at least a portion of link ECC) using the remaining quantity of bits. In some other examples, the memory system 110-a may communicate the security information using the one or more pins without communicating other information (e.g., link ECC information).

In some examples, the memory system 110-a may communicate the security information based on monitoring the one or more mode registers 220-a. In some cases, a value or status of the one or more mode registers 220-a may determine whether the memory system 110-a communicates the security information, link ECC, or a combination thereof. Each of the one or more mode registers 220-a may correspond to a respective function of the one or more pins. For example, a first mode register may enable communication of a quantity of ECC information and a quantity of security information via the sideband channel 210, a second mode register may enable communication of ECC information and no security information, and a third mode register may enable communication of security information and no ECC information, among other examples. Additionally, or alternatively, a single mode register 220-a (or some other quantity) may be configured to indicate one of multiple candidate values, where each candidate value is indicative of a respective sideband security mode. The host system 105-a, the memory system 110-a, or both, may set the values of the one or more of the mode registers 220. In some examples, the mode registers 220, the host system 105-a, a controller within the memory system 110-a, or any combination thereof may indicate timing associated with the use of the pins for exchanging security information. For example, the pins may be used for other purposes during one or more first time intervals and may be repurposed for the sideband channel 210 and exchange of the security information during one or more second time intervals.

Although DMI and RDQS pins are described as examples for communicating security information, it is to be understood that any pin may be used to communicate security information via the sideband channel 210. For example, any pin of the memory system 110-a that is capable of communicating information during a duration that at least partially overlaps with a duration in which data in the data channel 205 is used for communications may be repurposed for exchanging security information.

FIG. 2B shows an example of a system 200-b that supports communicating data security information via a sideband in a memory system in accordance with examples as disclosed herein. For example, the memory system 110-b may communicate security information with the host system 105-b via one or more subsets of bits 215 of a set of bits via a data channel 205-b. In some examples, the one or more subsets of bits 215 may be referred to as a sideband (e.g., a virtualized sideband channel).

In some examples, the memory system 110-b may communicate data via the data channel 205-b in data bursts using one or more DQ pins. For example, the memory system 110-b may communicate one or more sets of bits based on receiving one or more access operations (e.g., receive a first set of bits for a corresponding write operation, transmit a second set of bits for a corresponding read operation). A respective set of bits may include one or more subsets of bits 215, such as a quantity of data fields and a quantity of metadata fields. In some examples, the contents of the subsets of bits 215 (e.g., the contents of the metadata fields) may be based on the status or value of the one or more mode registers 220-b. For example, the subsets of bits 215 may include data bus inversion (DBI) bits, link ECC bits, EDC bits, or other metadata information bits, based on whether communication of those bits are enabled via the one or more mode registers 220-b. Additionally, or alternatively, in accordance with the techniques described herein, the memory system 110-a may communicate security information (security bits) via the one or more subsets of bits 215.

In some examples, the memory system 110-b may communicate a first portion of security information via one or more bits of a first subset of bits 215-a. In some cases, the first subset of bits 215-a may be associated with a first quantity of the one or more mode registers 220-b. For example, the first subset of bits 215-a (e.g., bits M0-M15 in a data burst) may correspond to a first set of functions associated with metadata bits that may be enabled or disabled via the first quantity of the one or more mode registers 220-b. Additionally, or alternatively, the memory system 110-b may communicate a second portion of security information via one or more bits of a second subset of bits 215-b. The second subset of bits 215-b may be associated with a second quantity of the one or more mode registers 220-b. For example, the second subset of bits 215-b (e.g., bits L0-L15 in a data burst) may correspond to a second set of functions associated with link ECC, EDC, or DBI that may be enabled or disabled via the second quantity of the one or more mode registers 220-b.

In some examples, the memory system 110-b may truncate one or more DBI bits, one or more link ECC bits, or a combination thereof, in a respective subset of bits 215 and communicate the security information using the remaining bits of the respective subset of bits 215. For example, a subset of bits 215 may include 16 bits. The memory system 110-b may truncate a quantity of link ECC bits from 16 bits to 8 bits and communicate the security information using the remaining 8 bits (e.g., the subset of bits 215 may include 8 bits of truncated link ECC bits and 8 bits of security information).

In some examples, the memory system 110-b may communicate security information via the one or more subsets of bits 215 for an authentication operation. For example, the memory system 110-b may authenticate an identity of the host system 105-b based on exchanging security information via the one or more subsets of bits 215. In some other examples, the host system 105-b may authenticate an identity of the memory system 110-b based on exchanging the security information. Additionally, or alternatively, the memory system 110-b, or the host system 105-b, may communicate security information using the one or more subsets of bits 215 to validate the data in the data channel 205-b. For example, during a read operation, the memory system 110-b may transmit security information in the one or more subsets of bits 215 that indicates one or more security parameters associated with the data. During a write operation, the memory system 110-b may receive security information via the one or more subsets of bits 215 that indicates the one or more security parameters.

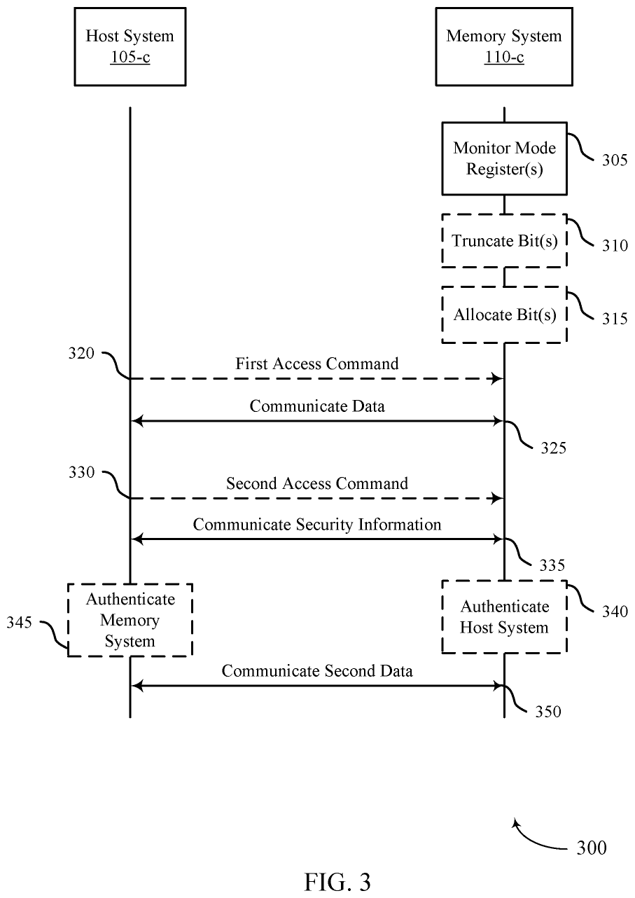

FIG. 3 shows an example of a process flow 300 that supports communicating data security information via a sideband in a memory system in accordance with examples as disclosed herein. The process flow 300 may be implemented by aspects of the system 100 or the systems 200, as described with reference to FIGS. 1 and 2. For example, the process flow 300 may be implemented by a host system 105-c and a memory system 110-c, which may be examples of the host system 105 and the memory system 110 as described with reference to FIG. 1. The process flow 300 may be an example of a process flow for the memory system 110-c to communicate security information with the host system 105-c using a sideband. For example, the memory system 110-c may communicate the security information via one or more pins of the memory system 110-c, as described with reference to FIG. 2A. Additionally, or alternatively, the memory system 110-c may communicate the security information via one or more bits of a data burst, as described with reference to FIG. 2B.

In the following description of the process flow 300, the operations may be performed in a different order than the order shown, or other operations may be added or removed from the process flow 300. For example, some operations may be left out of the process flow 300, may be performed in different orders or at different times, or other operations may be added to the process flow 300.

At 305, the memory system 110-c may monitor one or more mode registers of the memory system 110-c. A value of the mode registers may indicate the configuration and operation of sideband communications, including whether security information, link ECC, or a combination thereof is to be communicated between the memory system 110-c and the host system 105-c. In some examples, the values in the mode registers may be set by the host system 105-c, the memory system 110-c, or both.

At 310, the memory system 110-c may truncate one or more bits of a set of bits that include one or more DBI bits, link ECC, or both. In some examples, truncating the one or more bits may include reducing a quantity of bits allocated for DBI or link ECC to free-up bits for security information. In some cases, the memory system 110-c may truncate the one or more bits based on the values of the one or more mode registers.

At 315, the memory system 110-c may allocate the one or more bits (e.g., the remaining bits of the set of bits that were truncated) for communicating security information based on truncating the one or more bits. In some examples, the security information may include information that indicates whether data stored at the memory system 110-c is encoded, information that indicates an encoding format applied to the data, data validation information, a security tag associated with the data, command verification information, an identifier of the data, an identifier of the memory system 110-c, or any combination thereof.

At 320, the memory system 110-c may receive a first access command associated with data. In some examples, the memory system 110-c may receive the first access command via a data channel between the host system 105-c and the memory system 110-c. In some cases, the first access command may be a read or write command.

At 325, the memory system 110-c may communicate, with the host system 105-c during a first duration, data via the data channel. For example, the memory system 110-c may output data corresponding to the first access command (e.g., based on the first access command being a read command). Additionally, or alternatively, the memory system 110-c may obtain data corresponding to the first access command (e.g., based on the first access command being a write command). In some examples, the memory system 110-c may communicate the data via remaining bits of the set of bits after truncating the one or more bits.

At 330, the memory system 110-c may receive a second access command associated with the security information. In some examples, the second access command may be a read or write command (e.g., associated with the data). In some other examples, the second access command may request or transmit security information (e.g., the host system 105-c may request the security information from the memory system 110-c or write security information to the memory system 110-c).

At 335, the memory system 110-c may communicate, with the host system 105-c during a second duration that at least partially overlaps the first duration in which the data is communicated, the security information via the sideband. Although 335 and 325 are not shown as overlapping in FIG. 3, it is to be understood that the data and the security information may be exchanged within at least partially overlapping time periods (e.g., at the same time, interleaved in time, or both) based on the use of the sideband channel for exchanging the security information. In some examples, the memory system 110-c may communicate the security information based on a status of the one or more mode registers obtained by monitoring the one or more mode registers. In some cases, the memory system 110-c may communicate the security information via one or more pins of a sideband channel between the host system 105-c and the memory system 110-c. For example, the memory system 110-c may communicate the security information via one or more DMI pins, one or more RDQS bins, or both, based on receiving the first access command, the second access command, or both. In some examples, the memory system may communicate the security information via one or more RDQS pins in accordance with a data parity communication scheme of the memory system 110-c. The data parity communication scheme may be based on (e.g., configured, or otherwise determined) the status of the one or more mode registers.

Additionally, or alternatively, the memory system 110-c may communicate the security information via one or more subsets of bits of the set of bits. In some examples, the sideband may include the one or more subsets of bits (and/or the one or bits allocated for communicating the security information). In some cases, one or more respective data bits of the set of bits may be interleaved in time with respective subsets of bits of the one or more subsets of bits. In some examples, a first quantity of the one or more subsets of bits may be associated with (e.g., convey, indicate) metadata, ECC, DBI bits, or a combination thereof. In such examples, a second quantity of the one or more subsets of bits may be associated with (e.g., convey, indicate) the security information. In some cases, the first quantity of the one or more subsets of bits and the second quantity of the one or more subsets of bits may be based on the status of the one or more mode registers. For example, a first portion of the one or more mode registers may indicate the first quantity and a second portion of the one or more mode registers may indicate the second quantity.

At 340, in some examples, the memory system 110-c may authenticate an identity of the host system 105-c based on communicating the security information with the host system 105-c. In some examples, the authentication process may include verifying the credentials or identity (e.g., indicated by the security information) of the host system 105-c to determine whether the host system 105-c is authorized to access the memory system 110-c.

At 345, in some examples, the host system 105-c may authenticate an identity of the memory system 110-c based on communicating the security information with the memory system 110-c. The host system 105-c may verify the credentials (e.g., indicated by the security information) or identity of the memory system 110-c to determine whether the host system 105-c is communicating with an authorized memory system.

At 350, the memory system 110-c may communicate second data with the host system 105-c via the data channel based on authenticating the identity of the host system 105-c, the memory system 110-c, or both. For example, if the authentication at 340 or 345 is successful, the memory system 110-c and the host system 105-c may proceed with subsequent data and security information communication.

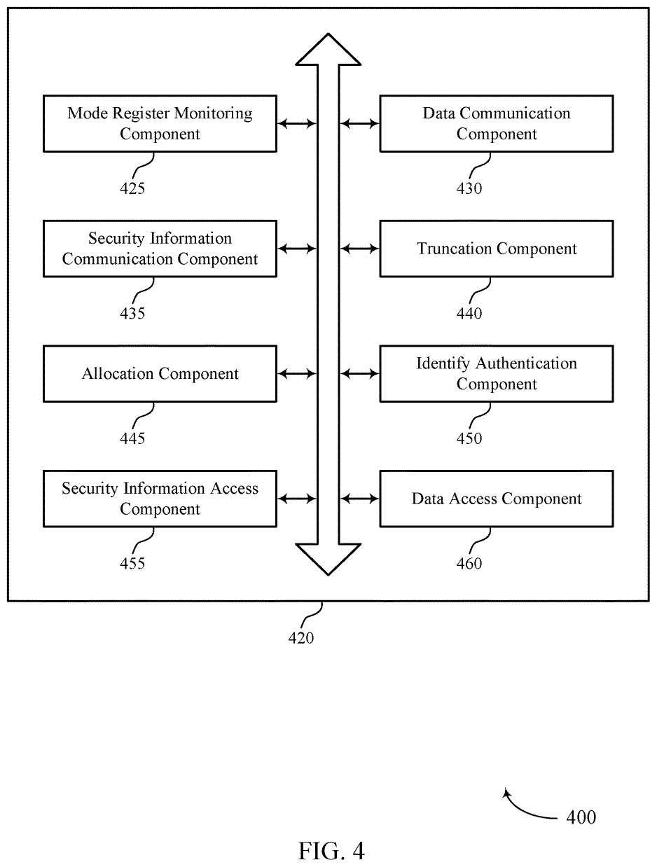

FIG. 4 shows a block diagram 400 of a memory system 420 that supports communicating data security information via a sideband in a memory system in accordance with examples as disclosed herein. The memory system 420 may be an example of aspects of a memory system as described with reference to FIGS. 1 through 3. The memory system 420, or various components thereof, may be an example of means for performing various aspects of communicating data security information via a sideband in a memory system as described herein. For example, the memory system 420 may include a mode register monitoring component 425, a data communication component 430, a security information communication component 435, a truncation component 440, an allocation component 445, an identify authentication component 450, a security information access component 455, a data access component 460, or any combination thereof. Each of these components, or components of subcomponents thereof (e.g., one or more processors, one or more memories), may communicate, directly or indirectly, with one another (e.g., via one or more buses).

The memory system 420 may support a memory system in accordance with examples as disclosed herein. The mode register monitoring component 425 may be configured as or otherwise support a means for monitoring one or more mode registers of the memory system. The data communication component 430 may be configured as or otherwise support a means for communicating, with a host system during a first duration, data via a data channel between the host system and the memory system. The security information communication component 435 may be configured as or otherwise support a means for communicating, with the host system during a second duration that at least partially overlaps the first duration in which the data is communicated, security information via a sideband between the host system and the memory system based at least in part on a status of the one or more mode registers obtained by monitoring the one or more mode registers.

In some examples, the security information is communicated via one or more pins of a channel between the host system and the memory system, the sideband including the channel and the one or more pins. In some examples, the security information access component 455 may be configured as or otherwise support a means for receiving an access command associated with the security information, where the security information is communicated via one or more DMI pins, one or more RDQS pins, or both, of the one or more pins based at least in part on receiving the access command.

In some examples, the data access component 460 may be configured as or otherwise support a means for receiving an access command associated with the data, where the security information is communicated via one or more DMI pins, one or more RDQS, or both, of the one or more pins based at least in part on receiving the access command. In some examples, the security information is communicated via one or more RDQS pins in accordance with a data parity communication scheme of the memory system, the data parity communication scheme being based at least in part on the status of the one or more mode registers.

In some examples, the truncation component 440 may be configured as or otherwise support a means for truncating one or more bits of a plurality of bits including one or more DBI bits, a link-ECC, or both, where the data is communicated via remaining bits of the plurality of bits after truncating the one or more bits. In some examples, the allocation component 445 may be configured as or otherwise support a means for allocating the one or more bits for communicating the security information based at least in part on truncating the one or more bits, where the sideband includes the one or more bits.

In some examples, the data is communicated via a plurality of bits, the security information is communicated via one or more subsets of bits of the plurality of bits, and the sideband includes the one or more subsets of bits. In some examples, one or more respective data bits of the plurality of bits are interleaved in time with respective subsets of bits of the one or more subsets of bits. In some examples, a first quantity of the one or more subsets of bits is associated with metadata, ECC, a DBI bits, or a combination thereof; a second quantity of the one or more subsets of bits is associated with the security information; and the first quantity and the second quantity are based at least in part on the status of the one or more mode registers.

In some examples, the identify authentication component 450 may be configured as or otherwise support a means for authenticating an identity of the host system, the memory system, or both based at least in part on communicating the security information with the host system. In some examples, the data communication component 430 may be configured as or otherwise support a means for communicating second data with the host system via the data channel based at least in part on authenticating the identity of the host system, the memory system, or both. In some examples, the security information includes information that indicates whether the data is encoded, information that indicates an encoding format applied to the data, data validation information, a security tag associated with the data, command verification information, an identifier of the data, an identifier of the memory system, or any combination thereof.

In some examples, the described functionality of the memory system 420, or various components thereof, may be supported by or may refer to at least a portion of at least one processor, where such at least one processor may include one or more processing elements (e.g., a controller, a microprocessor, a microcontroller, a digital signal processor, a state machine, discrete gate logic, discrete transistor logic, discrete hardware components, or any combination of one or more of such elements). In some examples, the described functionality of the memory system 420, or various components thereof, may be implemented at least in part by instructions (e.g., stored in memory, non-transitory computer-readable medium) executable by such at least one processor.

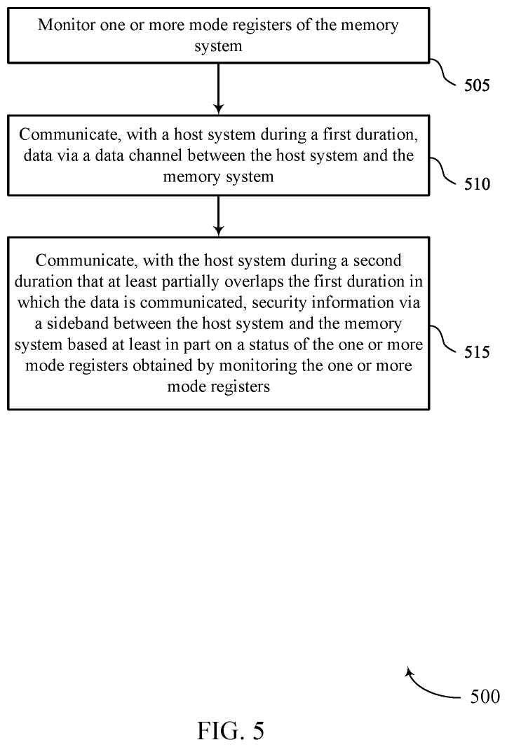

FIG. 5 shows a flowchart illustrating a method 500 that supports communicating data security information via a sideband in a memory system in accordance with examples as disclosed herein. The operations of method 500 may be implemented by a memory system or its components as described herein. For example, the operations of method 500 may be performed by a memory system as described with reference to FIGS. 1 through 4. In some examples, a memory system may execute a set of instructions to control the functional elements of the device to perform the described functions. Additionally, or alternatively, the memory system may perform aspects of the described functions using special-purpose hardware.

At 505, the method may include monitoring one or more mode registers of the memory system. In some examples, aspects of the operations of 505 may be performed by a mode register monitoring component 425 as described with reference to FIG. 4.

At 510, the method may include communicating, with a host system during a first duration, data via a data channel between the host system and the memory system. In some examples, aspects of the operations of 510 may be performed by a data communication component 430 as described with reference to FIG. 4.

At 515, the method may include communicating, with the host system during a second duration that at least partially overlaps the first duration in which the data is communicated, security information via a sideband between the host system and the memory system based at least in part on a status of the one or more mode registers obtained by monitoring the one or more mode registers. In some examples, aspects of the operations of 515 may be performed by a security information communication component 435 as described with reference to FIG. 4.

In some examples, an apparatus as described herein may perform a method or methods, such as the method 500. The apparatus may include features, circuitry, logic, means, or instructions (e.g., a non-transitory computer-readable medium storing instructions executable by a processor), or any combination thereof for performing the following aspects of the present disclosure:
Aspect 1: A method, apparatus, or non-transitory computer-readable medium including operations, features, circuitry, logic, means, or instructions, or any combination thereof for monitoring one or more mode registers of the memory system; communicating, with a host system during a first duration, data via a data channel between the host system and the memory system; and communicating, with the host system during a second duration that at least partially overlaps the first duration in which the data is communicated, security information via a sideband between the host system and the memory system based at least in part on a status of the one or more mode registers obtained by monitoring the one or more mode registers.
Aspect 2: The method, apparatus, or non-transitory computer-readable medium of aspect 1, where the security information is communicated via one or more pins of a channel between the host system and the memory system, the sideband including the channel and the one or more pins.
Aspect 3: The method, apparatus, or non-transitory computer-readable medium of aspect 2, further including operations, features, circuitry, logic, means, or instructions, or any combination thereof for receiving an access command associated with the security information, where the security information is communicated via one or more data mask inversion pins, one or more read data strobe pins, or both, of the one or more pins based at least in part on receiving the access command.
Aspect 4: The method, apparatus, or non-transitory computer-readable medium of any of aspects 2 through 3, further including operations, features, circuitry, logic, means, or instructions, or any combination thereof for receiving an access command associated with the data, where the security information is communicated via one or more data mask inversion pins, one or more read data strobe pins, or both, of the one or more pins based at least in part on receiving the access command.
Aspect 5: The method, apparatus, or non-transitory computer-readable medium of any of aspects 2 through 4, where the security information is communicated via one or more read data strobe pins in accordance with a data parity communication scheme of the memory system, the data parity communication scheme being based at least in part on the status of the one or more mode registers.
Aspect 6: The method, apparatus, or non-transitory computer-readable medium of any of aspects 1 through 5, further including operations, features, circuitry, logic, means, or instructions, or any combination thereof for truncating one or more bits of a plurality of bits including one or more data bus inversion bits, a link-error correction code, or both, where the data is communicated via remaining bits of the plurality of bits after truncating the one or more bits and allocating the one or more bits for communicating the security information based at least in part on truncating the one or more bits, where the sideband includes the one or more bits.
Aspect 7: The method, apparatus, or non-transitory computer-readable medium of any of aspects 1 through 6, where the data is communicated via a plurality of bits, the security information is communicated via one or more subsets of bits of the plurality of bits, and the sideband includes the one or more subsets of bits.
Aspect 8: The method, apparatus, or non-transitory computer-readable medium of aspect 7, where one or more respective data bits of the plurality of bits are interleaved in time with respective subsets of bits of the one or more subsets of bits.
Aspect 9: The method, apparatus, or non-transitory computer-readable medium of any of aspects 7 through 8, where a first quantity of the one or more subsets of bits is associated with metadata, error correction code, a data bus inversion bits, or a combination thereof; a second quantity of the one or more subsets of bits is associated with the security information; and the first quantity and the second quantity are based at least in part on the status of the one or more mode registers.
Aspect 10: The method, apparatus, or non-transitory computer-readable medium of any of aspects 1 through 9, further including operations, features, circuitry, logic, means, or instructions, or any combination thereof for authenticating an identity of the host system, the memory system, or both based at least in part on communicating the security information with the host system and communicating second data with the host system via the data channel based at least in part on authenticating the identity of the host system, the memory system, or both.
Aspect 11: The method, apparatus, or non-transitory computer-readable medium of any of aspects 1 through 10, where the security information includes information that indicates whether the data is encoded, information that indicates an encoding format applied to the data, data validation information, a security tag associated with the data, command verification information, an identifier of the data, an identifier of the memory system, or any combination thereof.

It should be noted that the aspects described herein describe possible implementations, and that the operations and the steps may be rearranged or otherwise modified and that other implementations are possible. Further, portions from two or more of the methods may be combined.

Information and signals described herein may be represented using any of a variety of different technologies and techniques. For example, data, instructions, commands, information, signals, bits, or symbols of signaling that may be referenced throughout the above description may be represented by voltages, currents, electromagnetic waves, magnetic fields or particles, optical fields or particles, or any combination thereof. Some drawings may illustrate signals as a single signal; however, the signal may represent a bus of signals, where the bus may have a variety of bit widths.

The terms “electronic communication,” “conductive contact,” “connected,” and “coupled” may refer to a relationship between components that supports the flow of signals between the components. Components are considered in electronic communication with (e.g., in conductive contact with, connected with, coupled with) one another if there is any electrical path (e.g., conductive path) between the components that can, at any time, support the flow of signals (e.g., charge, current, voltage) between the components. A conductive path between components that are in electronic communication with each other (e.g., in conductive contact with, connected with, coupled with) may be an open circuit or a closed circuit based on the operation of the device that includes the connected components. A conductive path between connected components may be a direct conductive path between the components or may be an indirect conductive path that includes intermediate components, such as switches, transistors, or other components. In some examples, the flow of signals between the connected components may be interrupted for a time, for example, using one or more intermediate components such as switches or transistors.

A switching component (e.g., a transistor) discussed herein may be a field-effect transistor (FET), and may include a source (e.g., a source terminal), a drain (e.g., a drain terminal), a channel between the source and drain, and a gate (e.g., a gate terminal). A conductivity of the channel may be controlled (e.g., modulated) by applying a voltage to the gate which, in some examples, may result in the channel becoming conductive. A switching component may be an example of an n-type FET or a p-type FET.

The description set forth herein, in connection with the appended drawings, describes example configurations and does not represent all the examples that may be implemented or that are within the scope of the claims. The detailed description includes specific details to provide an understanding of the described techniques. These techniques, however, may be practiced without these specific details. In some instances, well-known structures and devices are shown in block diagram form to avoid obscuring the concepts of the described examples.

In the appended figures, similar components or features may have the same reference label. Similar components may be distinguished by following the reference label by one or more dashes and additional labeling that distinguishes among the similar components. If just the first reference label is used in the specification, the description is applicable to any one of the similar components having the same first reference label irrespective of the additional reference labels.

The functions described herein may be implemented in hardware, instructions (e.g., code, software, firmware, logic) executed by a processing system (e.g., one or more processors, one or more controllers, control circuitry, processing circuitry, logic circuitry), or any combination thereof that is configured to cause a respective apparatus, device, or system to perform the described functions. If implemented as instructions executed by a processing system, the functions may be stored on or transmitted over as one or more instructions on a computer-readable medium. Due to the nature of software, functions described herein can be implemented using software executed by a processing system, hardware, firmware, hardwiring, or combinations of any of these. Features implementing functions may be physically located at various positions, including being distributed such that portions of functions are implemented at different physical locations.

Illustrative blocks and modules described herein may be implemented or performed with one or more processors, such as a DSP, an ASIC, an FPGA, discrete gate logic, discrete transistor logic, discrete hardware components, other programmable logic device, or any combination thereof, that are configured to cause the performance of the functions described herein. A processor may be an example of a microprocessor, a controller, a microcontroller, a state machine, or other types of processors. A processor may also be implemented as at least one of one or more computing devices (e.g., a combination of a DSP and a microprocessor, multiple microprocessors, one or more microprocessors in conjunction with a DSP core, or any other such configuration).

As used herein, including in the claims, “or” as used in a list of items (for example, a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an exemplary step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.” Similarly, subsequent reference to a component introduced as “one or more components” using the terms “the” or “said” may refer to any or all of the one or more components. For example, referring to “the one or more components” subsequently in the claims may be understood to be equivalent to referring to “at least one of the one or more components.”

Computer-readable media includes both non-transitory computer storage media and communication media including any medium that facilitates transfer of a computer program from one place to another. A non-transitory storage medium may be any available medium, or combination of multiple media, which can be accessed by a computer. By way of example, and not limitation, non-transitory computer-readable media can comprise RAM, ROM, electrically erasable programmable read-only memory (EEPROM), optical disk storage, magnetic disk storage or other magnetic storage devices, or any other non-transitory medium or combination of media that can be used to carry or store desired program code means in the form of instructions or data structures and that can be accessed by a computer, or one or more processors.

The descriptions and drawings are provided to enable a person having ordinary skill in the art to make or use the disclosure. Various modifications to the disclosure will be apparent to the person having ordinary skill in the art, and the techniques disclosed herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for a memory system, comprising:
processing circuitry associated with one or more memory devices and configured to cause the apparatus to:
monitor one or more mode registers of the memory system;
communicate, with a host system during a first duration, data via a data channel between the host system and the memory system; and
communicate, with the host system during a second duration that at least partially overlaps the first duration in which the data is communicated, security information via a sideband between the host system and the memory system based at least in part on a status of the one or more mode registers obtained by monitoring the one or more mode registers.

2. The apparatus of claim 1, wherein the security information is communicated via one or more pins of a channel between the host system and the memory system, the sideband comprising the channel and the one or more pins.

3. The apparatus of claim 2, wherein the processing circuitry is further configured to cause the apparatus to:
receive an access command associated with the security information, wherein the security information is communicated via one or more data mask inversion pins, one or more read data strobe pins, or both, of the one or more pins based at least in part on receiving the access command.

4. The apparatus of claim 2, wherein the processing circuitry is further configured to cause the apparatus to:
receive an access command associated with the data, wherein the security information is communicated via one or more data mask inversion pins, one or more read data strobe pins, or both, of the one or more pins based at least in part on receiving the access command.

5. The apparatus of claim 2, wherein the security information is communicated via one or more read data strobe pins in accordance with a data parity communication scheme of the memory system, the data parity communication scheme being based at least in part on the status of the one or more mode registers.

6. The apparatus of claim 1, wherein the processing circuitry is further configured to cause the apparatus to:
truncate one or more bits of a plurality of bits comprising one or more data bus inversion bits, a link-error correction code, or both, wherein the data is communicated via remaining bits of the plurality of bits after truncating the one or more bits; and
allocate the one or more bits for communicating the security information based at least in part on truncating the one or more bits, wherein the sideband comprises the one or more bits.

7. The apparatus of claim 1, wherein:
the data is communicated via a plurality of bits;
the security information is communicated via one or more subsets of bits of the plurality of bits; and
the sideband comprises the one or more subsets of bits.

8. The apparatus of claim 7, wherein one or more respective data bits of the plurality of bits are interleaved in time with respective subsets of bits of the one or more subsets of bits.

9. The apparatus of claim 7, wherein:
a first quantity of the one or more subsets of bits is associated with metadata, error correction code, a data bus inversion bits, or a combination thereof;
a second quantity of the one or more subsets of bits is associated with the security information; and
the first quantity and the second quantity are based at least in part on the status of the one or more mode registers.

10. The apparatus of claim 1, wherein the processing circuitry is further configured to cause the apparatus to:
authenticate an identity of the host system, the memory system, or both based at least in part on communicating the security information with the host system; and
communicate second data with the host system via the data channel based at least in part on authenticating the identity of the host system, the memory system, or both.

11. The apparatus of claim 1, wherein the security information comprises information that indicates whether the data is encoded, information that indicates an encoding format applied to the data, data validation information, a security tag associated with the data, command verification information, an identifier of the data, an identifier of the memory system, or any combination thereof.

12. A method for a memory system, comprising:
monitoring one or more mode registers of the memory system;
communicating, with a host system during a first duration, data via a data channel between the host system and the memory system; and
communicating, with the host system during a second duration that at least partially overlaps the first duration in which the data is communicated, security information via a sideband between the host system and the memory system based at least in part on a status of the one or more mode registers obtained by monitoring the one or more mode registers.

13. The method of claim 12, wherein the security information is communicated via one or more pins of a channel between the host system and the memory system, the sideband comprising the channel and the one or more pins.

14. The method of claim 13, further comprising:
receiving an access command associated with the security information, wherein the security information is communicated via one or more data mask inversion pins, one or more read data strobe pins, or both, of the one or more pins based at least in part on receiving the access command.

15. The method of claim 13, further comprising:
receiving an access command associated with the data, wherein the security information is communicated via one or more data mask inversion pins, one or more read data strobe pins, or both, of the one or more pins based at least in part on receiving the access command.

16. The method of claim 13, wherein the security information is communicated via one or more read data strobe pins in accordance with a data parity communication scheme of the memory system, the data parity communication scheme being based at least in part on the status of the one or more mode registers.

17. The method of claim 12, further comprising:
truncating one or more bits of a plurality of bits comprising one or more data bus inversion bits, a link-error correction code, or both, wherein the data is communicated via remaining bits of the plurality of bits after truncating the one or more bits; and
allocating the one or more bits for communicating the security information based at least in part on truncating the one or more bits, wherein the sideband comprises the one or more bits.

18. The method of claim 12, wherein:
the data is communicated via a plurality of bits;
the security information is communicated via one or more subsets of bits of the plurality of bits; and
the sideband comprises the one or more subsets of bits.

19. The method of claim 12, further comprising:
authenticating an identity of the host system, the memory system, or both based at least in part on communicating the security information with the host system; and
communicating second data with the host system via the data channel based at least in part on authenticating the identity of the host system, the memory system, or both.

20. A non-transitory computer-readable medium storing code for a memory system, the code comprising instructions executable by one or more processors to:
monitor one or more mode registers of the memory system;
communicate, with a host system during a first duration, data via a data channel between the host system and the memory system; and
communicate, with the host system during a second duration that at least partially overlaps the first duration in which the data is communicated, security information via a sideband between the host system and the memory system based at least in part on a status of the one or more mode registers obtained by monitoring the one or more mode registers.
